(19) United States
(12) Patent Application Publication
(10) Pub. No.: US 2025/0272264 A1
(43) Pub. Date: Aug. 28, 2025

(54) INTELLIGENT CLOUD-BASED INFORMATION DISTRIBUTION SYSTEM FOR ONLINE PAYMENT

(71) Applicant: XUHUI CAI, SINGAPORE (SG)

(72) Inventor: XUHUI CAI, SINGAPORE (SG)

(21) Appl. No.: 18/585,266

(22) Filed: Feb. 23, 2024

(51) Int. Cl. G06Q 20/12; H04L 67/10

(52) U.S. Cl. CPC G06F 16/134; H04L 67/10

(57) ABSTRACT

An intelligent cloud-based information distribution system for online payment is provided and includes: an information distribution module, a managing and controlling module, and a system management module. The information distribution module is configured to distributing and transmitting files. The managing and controlling module includes a central control sub-module and an indexing service sub-module. The central control sub-module is configured to control each component to operate and to display global information. The indexing service sub-module is configured to record correspondence between distribution nodes and resources. The system management module is configured to maintain normal operation of the system. Each region is configured with a bridgehead node to associate all distribution nodes within the region and to achieve resource interaction. The number of distribution nodes to be invoked is reduced. Information services are provided for operators optimally, a utilization rate of the bandwidth for data transmission is improved.

### TECHNICAL FIELD

The present disclosure relates to a technical field of information, and in particular to an intelligent cloud-based information distribution system for online payment.

### BACKGROUND

Online payment refers to a business in which a bank provides online fund settlement services for sellers and buyers when the sellers and buyers are conducting transactions on e-commerce websites on the Internet. The online payment provides a safe, fast and convenient e-commerce application environment and an online fund settlement tool for enterprises and individuals. As the cloud computing technology emerges, cloud data has become a mainstream of data centers. Cloud data provides various services, applications, and other computing resources by distributing different virtual machine mirrors.

In an application scenario of a cloud data center, distribution of virtual machine mirrors is often required. Files of the virtual machine mirrors usually occupy a very large space, and in addition to the huge number of hosts in a server network, P2P networks in the related art cannot distribute large data files efficiently. When multiple data centers are located far away from each other, distribution of virtual machine mirrors has high requirements for bandwidth resources of a backbone network.

### SUMMARY OF THE DISCLOSURE

The present disclosure provides an intelligent cloud-based information distribution system for online payment to solve the above technical problems.

In an aspect, an intelligent cloud-based information distribution system for online payment is provided and includes: an information distribution module, a managing and controlling module, and a system management module. The information distribution module is configured to distributing and transmitting files, the managing and controlling module includes a central control sub-module and an indexing service sub-module; the central control sub-module is configured to control each component to operate and to display global information; the indexing service sub-module is configured to record correspondence between distribution nodes and resources; the system management module is configured to maintain normal operation of the intelligent cloud-based information distribution system.

In some embodiments, the information distribution module includes a file interaction sub-module, a file verification sub-module, a parameter configuration sub-module, and an information recovery sub-module; the file interaction sub-module is configured to upload, release, download, and receive the files; the file verification sub-module is configured to verify the files slice by slice in a process of transmitting the files; the parameter configuration sub-module is configured to modify various parameters according to usage requirements; the information recovery sub-module is configured to interrupt connection or trigger a recovery process when an error occurs in block connection.

In some embodiments, functions of the central control sub-module include: task control, node control, and global information displaying; the task control refers to showing information of a current task after an operator selects the current task; the node control refers to showing all distribution nodes and showing operation states of some of the distribution nodes that are selected by the operator. The global information displaying refers to displaying statistical data to the operator to enable the operator to view a current running state.

In some embodiments, functions of the indexing service sub-module include: data processing, information processing, and disconnection processing; the data processing refers to storing and invoking the distribution nodes and resource files; the information processing refers to transmitting and processing messages; the disconnection processing refers to detailed operations relating to disconnection.

In some embodiments, functions of the system management module include: error detection, authority management, and differential synchronization; the error detection refers to monitoring an operation state of the system to determine whether any fault occurs; the authority management refers to, after verifying an identity of the operator, activating an operation permission for the operator; the differential synchronization refers to, after a full backup or a last incremental backup, backing up only an additional file or a modified file compared to the previous backup.

In some embodiments, each of various regions is arranged with a bridgehead node; the bridgehead node includes all IPs that correspond to a regional node and aggregates all messages and all files of the respective one of the various regions; the bridgehead node of one of the various regions is configured to perform centralized information interaction and file transmission with the bridgehead node of another one of the various regions; the bridgehead nodes and the indexing service sub-module of the managing and controlling module establish an interactive association state link.

In some embodiments, when a distribution node requests resources from an indexing service, the indexing service returns, in response to any node in the instant region having resources, information of the distribution node that has the resources to the requestor. After the requestor obtains the information of the distribution node, the requestor requests the resources from all distribution nodes in a list successively for downloading. When the resources that are required by the requester are not present in the instant region, following operations are performed. The indexing service initiates a connection with the bridgehead node in the instant region to request resources. After receiving the request of the resources, the bridgehead node in the instant region sends a request of the resources to the indexing service. The indexing service sends the list of bridgehead nodes, which have the resources, of other regions to the bridgehead node in the instant region. The bridgehead node in the instant region establishes connection to the bridgehead nodes of the other regions that have the requested successively, so as to complete downloading the resources. The bridgehead node in the instant region, after obtaining the resources, transmits the resources to the requester to complete inter-regional transmission.

According to the present disclosure, the distribution nodes and the indexing services, under monitoring of the managing and controlling module, distributes the cloud information. Each of the various regions is configured with the respective bridgehead node, the bridgehead node of one region associates all distribution nodes within the region. Therefore, the various regions use the respective bridgehead nodes to perform interaction, and the number of distribution nodes to be invoked for distributing files is reduced. In this way, information services are provided for operators optimally, a utilization rate of the bandwidth for data transmission is improved, and the data is transmitted more efficiently.

### BRIEF DESCRIPTION OF THE DRAWINGS

FIG. 1 is a block diagram of an architecture of an intelligent cloud-based information distribution system for online payment according to one embodiment of the present disclosure.

### DETAILED DESCRIPTION

Technical solutions in the embodiments of the present disclosure will be described clearly and completely in the following by referring to the accompanying drawings of the present disclosure. Apparently, the described embodiments are only a part of but not all of the embodiments of the present disclosure. All other embodiments, which are obtained by any ordinary skilled person in the art based on the embodiments in the present disclosure without making creative work, shall fall within the scope of the present disclosure.

### Embodiments

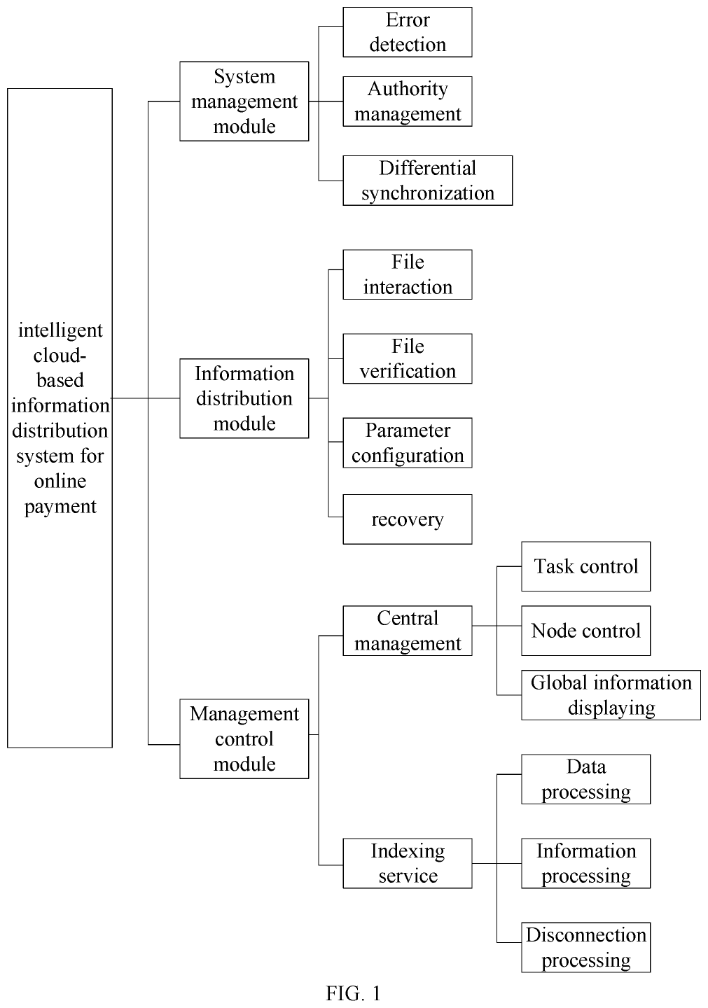

FIG. 1 shows an intelligent cloud-based information distribution system for online payment. The system includes an information distribution module, a managing and controlling module, and a system management module. The information distribution module is configured to distributing and transmitting files. The managing and controlling module includes a central control sub-module and an indexing service sub-module. The central control sub-module is configured to control each component to operate and to display global information. The indexing service sub-module is configured to record correspondence between the distribution nodes and resources. The system management module is configured to maintain normal operation of the intelligent cloud-based information distribution system.

The information distribution module includes a file interaction sub-module, a file verification sub-module, a parameter configuration sub-module, and an information recovery sub-module. The file interaction sub-module is configured to upload, release, download, and receive the files. The file verification sub-module is configured to verify the files slice by slice in a process of transmitting the files. The parameter configuration sub-module is configured to modify various parameters according to usage requirements. The information recovery sub-module is configured to interrupt connection or trigger a recovery process when an error occurs in block connection.

The parameter configuration sub-module includes static configuration items and dynamic configuration items. The static configuration items are stored in a configuration file. After the static configuration items are modified, the modified static configuration items are effective only when a program is restarted. The dynamic configuration items are effective instantly after being configured. Any configured parameter of the static configuration items and the dynamic configuration items can be modified and configured by a management front-end. Specifically, the configuration items include following items.

The static configuration items include: an IP address and a monitoring port of the indexing service, a local IP address and a local monitoring port, a list of local regional nodes, a default storage directory of a downloaded file. The dynamic configuration items include: a global maximum uploading speed, a global minimum uploading speed, the global maximum number of connections, a maximum uploading speed for one file, a minimum uploading speed for one file, the maximum number of connections for one file, a maximum uploading speed for one distribution node, a minimum uploading speed for one distribution node, the maximum number of connections for one distribution node, pausing uploading or downloading a resource, resuming uploading or downloading a resource, ceasing uploading or downloading a resource and deleting relevant node information.

Functions of the central control sub-module include: task control, node control, global information displaying. The task control refers to showing information of a current task after an operator selects the current task. The node control refers to showing all distribution nodes and showing operation states of some of the distribution nodes that are selected by the operator. The global information displaying refers to displaying statistical data to the operator to enable the operator to view the statistical data at any time to understand a current running state.

Functions of the indexing service sub-module include: data processing, information processing, and disconnection processing. The data processing refers to storing and invoking the distribution nodes and the resource files. The information processing refers to transmitting and processing messages. The disconnection processing refers to detailed operations relating to disconnection.

The system management module includes error detection, authority management, and differential synchronization. The error detection refers to monitoring an operation state of the system to determine whether any fault occurs. The authority management refers to, after verifying an identity of the operator, activating an operation permission for the operator. The differential synchronization refers to, after a full backup or a last incremental backup, backing up only the additional file or modified file compared to the previous backup.

In the system, each region is arranged with a bridgehead node. The bridgehead node of one region includes IPs of all other bridgehead nodes and aggregates all messages and all files of the instant region. The bridgehead node of the instant region performs centralized information interaction and file transmission with a bridgehead node of another region. The bridgehead nodes and the indexing service sub-module of the managing and controlling module establish an interactive association state link.

The information distribution module is configured with an internal interface and an external interface. The internal interface is configured for various components of the information distribution module interacting with each other. The external interface is configured to enable the information distribution module to interact with other modules. The information distribution module is arranged with a buffer. One connection between one distribution node and one indexing service corresponds to one buffer and is configured to store messages that are received and messages that are to be sent.

According to the present disclosure, the distribution nodes and the indexing services, under monitoring of the managing and controlling module, distributes the cloud information. Each of a plurality of regions is configured with the respective one bridgehead node. The bridgehead node of one region associates all distribution nodes within the instant region. Therefore, the plurality of regions use the respective bridgehead nodes to perform interaction with each other, and the number of distribution nodes to be invoked for distributing files is reduced. In this way, information services are provided for operators optimally, a utilization rate of the bandwidth for data transmission is improved, and the data is transmitted more efficiently.

Although embodiments of the present disclosure have been shown and described, any ordinary skilled person in the art shall can perform various changes, modifications, substitutions and variations on the embodiments without departing from the principle and spirit of the present disclosure. The scope of the present disclosure is limited by the appended claims and equivalents thereof.

1. An intelligent cloud-based information distribution system for online payment, comprising at least one processor and a non-transitory computer-readable storage medium that is coupled to the at least one processor and that stores computer-readable program instructions that are executable by the at least one processor, the computer-readable program instructions comprising: an information distribution module, a managing and controlling module, and a system management module; wherein the information distribution module is configured to distributing and transmitting files, the managing and controlling module comprises a central control sub-module and an indexing service sub-module; the central control sub-module is configured to control each component to operate and to display global information; the indexing service sub-module is configured to record correspondence between distribution nodes and resources; the system management module is configured to maintain normal operation of the intelligent cloud-based information distribution system;
wherein the information distribution module comprises a file interaction sub-module, a file verification sub-module, a parameter configuration sub-module, and an information recovery sub-module; the file interaction sub-module is configured to upload, release, download, and receive the files; the file verification sub-module is configured to verify the files slice by slice in a process of transmitting the files; the parameter configuration sub-module is configured to modify various parameters according to usage requirements; the information recovery sub-module is configured to interrupt connection or trigger a recovery process when an error occurs in block connection.

2. (canceled)

3. The intelligent cloud-based information distribution system according to claim 1, wherein the central control sub-module comprises following functions: task control, node control, and global information displaying; the task control refers to showing information of a current task after an operator selects the current task; the node control refers to showing all distribution nodes and showing operation states of some of the distribution nodes that are selected by the operator; the global information displaying refers to displaying statistical data to the operator to enable the operator to view the statistical data at any time to understand a current running state.

4. The intelligent cloud-based information distribution system according to claim 1, wherein the indexing service sub-module comprises following functions: data processing, information processing, and disconnection processing; the data processing refers to storing and invoking the distribution nodes and resource files; the information processing refers to transmitting and processing messages; the disconnection processing refers to detailed operations relating to disconnection.

5. The intelligent cloud-based information distribution system according to claim 1, wherein the system management module comprises following functions: error detection, authority management, and differential synchronization; the error detection refers to monitoring an operation state of the system to determine whether any fault occurs; the authority management refers to, after verifying an identity of an operator, activating an operation permission for the operator; the differential synchronization refers to, after a full backup or a last incremental backup, backing up only an additional file or a modified file compared to the previous backup.

6. The intelligent cloud-based information distribution system according to claim 1, wherein each of various regions is arranged with a bridgehead node; the bridgehead node comprises all IPs that correspond to a regional node and aggregates all messages and all files of the respective one of the various regions; the bridgehead node of one of the various regions is configured to perform centralized information interaction and file transmission with the bridgehead node of another one of the various regions; the bridgehead nodes and the indexing service sub-module of the managing and controlling module establish an interactive association state link.

7. The intelligent cloud-based information distribution system according to claim 1, wherein the parameter configuration sub-module comprises static configuration items and dynamic configuration items; wherein the static configuration items are stored in a configuration file, after the static configuration items are modified, the modified static configuration items are effective only when a program is restarted; wherein the dynamic configuration items are effective instantly after being configured;
wherein any configured parameter of the static configuration items and the dynamic configuration items is operative to be modified and configured by a management front-end.

8. The intelligent cloud-based information distribution system according to claim 7, wherein the static configuration items comprise an IP address and a monitoring port of the indexing service, a local IP address and a local monitoring port, a list of local regional nodes, a default storage directory of a downloaded file; wherein the dynamic configuration items comprise a global maximum uploading speed, a global minimum uploading speed, a global maximum number of connections, a maximum uploading speed for one file, a minimum uploading speed for one file, a maximum number of connections for one file, a maximum uploading speed for one distribution node, a minimum uploading speed for one distribution node, a maximum number of connections for one distribution node, pausing uploading or downloading a resource, resuming uploading or downloading a resource, ceasing uploading or downloading a resource, and deleting relevant node information.

9. The intelligent cloud-based information distribution system according to claim 1, wherein the information distribution module is configured with an internal interface and an external interface; wherein the internal interface is configured for various components of the information distribution module interacting with each other, and wherein the external interface is configured to enable the information distribution module to interact with other modules;
wherein the information distribution module is arranged with a buffer; wherein one connection between one distribution node and one indexing service corresponds to one buffer and is configured to store messages that are received and messages that are to be sent.
